(19) United States
(12) Patent Application Publication
(10) Pub. No.: US 2008/0036864 A1
(43) Pub. Date: Feb. 14, 2008

(54) System and method for capturing and transmitting image data streams

(76) Inventors: David McCubbrey, Ann Arbor, MI (US); Eric Sieczka, Ann Arbor, MI (US)

Correspondence Address: SCHOX PLC, 209 N. MAIN STREET #200, ANN ARBOR, MI, 48104, US

(21) Appl. No.: 11/891,516

(22) Filed: Aug. 8, 2007

Related U.S. Application Data
(60) Provisional application No. 60/821,941, filed on Aug. 9, 2006.

(51) Int. Cl. H04N 7/18

(52) U.S. Cl. 348/159

(57) ABSTRACT

A method and system for capturing and transmitting image data streams. In one embodiment, the method includes capturing image data with a image sensor; creating a window within the image data and creating a detailed image data stream based on the windowed image data; reducing the image data and creating a contextual image data stream based on the reduced image data; and transmitting the detailed image data stream and the contextual image data stream.

### CROSS-REFERENCE TO RELATED APPLICATIONS

This application claims the benefit of U.S. Provisional Application No. 60/821,941, entitled “Concept for Inexpensive High Resolution Remote Cameras” and filed on 9 Aug. 2006, which is incorporated in its entirety by this reference.

### TECHNICAL FIELD

This invention relates generally to the surveillance field, and more specifically to an improved system and methods for capturing and transmitting images in the surveillance field.

### BACKGROUND

Cameras, including both still cameras and video encoders, are often used to survey a building, a site, or other locations. Because the camera can typically gather more information than the communication network can handle, the camera produces and transmits a compressed version of the image or video. While there are some compression algorithms that can preserve all of the information of the image or video, the most effective compression algorithms drop information (and create “lossy” images or video). There are three problems with this approach. First, real-time compression requires significant computational effort, adding to the cost of the sensor. Second, for analytics and/or viewing, each compressed video stream then needs to be decompressed at the central server, adding additional cost and time. Third, automatic image analysis is compromised when using lossy images or video.

The cost components of remote sensor systems are typically in the expense of cabling and the electronics. Typically, the 100 Mbit/sec CAT-5 cable has inadequate capacity to transport high resolution imagery at high speed. For instance, moving data from a single HDTV sensor (1920 pixels×1080 pixels×12 bit/pixel at 60 frames/second) requires approximately 2 Gbits/sec communications bandwidth (approximately 20 times more bandwidth than the 100 Mbit/sec CAT-5 cable). Traditional solutions to this problem are to use higher bandwidth cable (more expensive) and compression techniques such as MJPEG, MPEG-2 or MPEG-4. The compression techniques have the drawbacks of requiring considerable computation, thus raising the overall cost and power requirements of the system. In addition, such techniques, being lossy, reduce the recovered image quality after decompression and thus impede automatic analysis at the image server.

Thus, there is a need in the surveillance field to create a new and useful system and method for capturing and transmitting images. This invention provides such a new and useful system and method.

### BRIEF DESCRIPTION OF THE FIGURES

FIG. 1A is a schematic representation of the system of the preferred embodiment, with a first variation of the communication link.

FIG. 1B is a schematic representation of the system of the preferred embodiment, with a second variation of the communication link.

FIG. 2 is a schematic representation of the functional blocks of the image controller of the preferred embodiment.

FIG. 3 is a flowchart representation of the method of the preferred embodiment.

FIG. 4 is an example of the method of the preferred embodiment.

FIG. 5 is a flowchart representation of a portion of the method of the preferred embodiment.

FIG. 6 is an example of the capacity requirements of a portion of the method of the preferred embodiment.

FIG. 7 is an example of a portion of the method of the preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

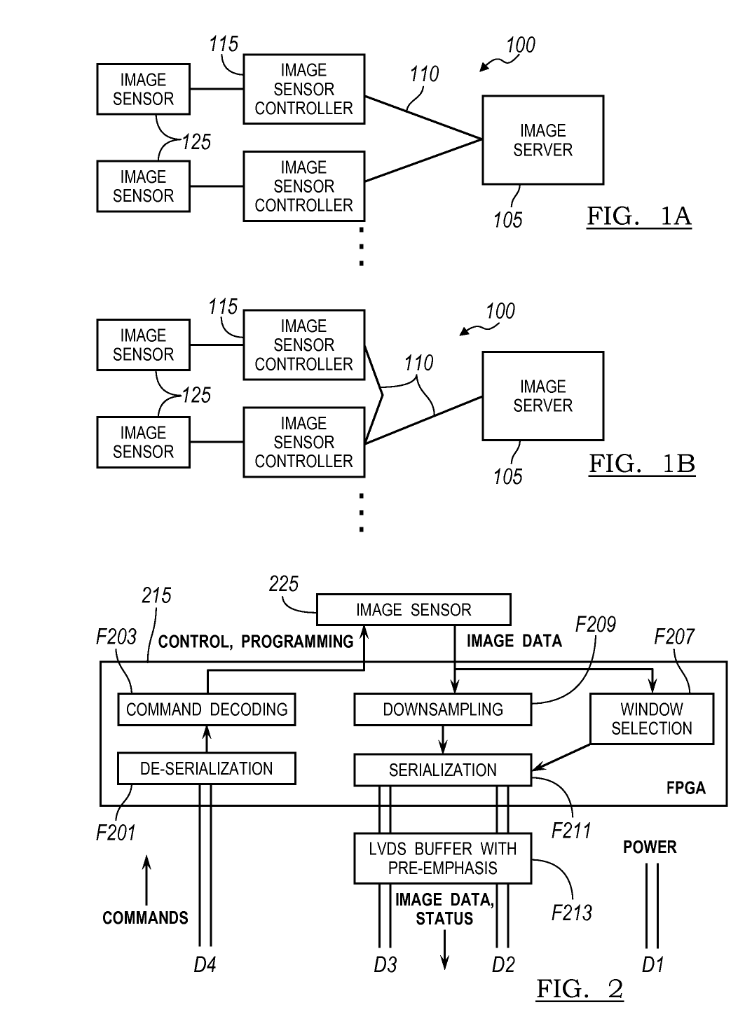

As shown in FIGS. 1A and 1B, the system 100 of the preferred embodiment includes at least two image sensors 125, at least two image sensor processors (or “image sensor controller”) 115, an image server 105 and at least one communication link 110 between the image sensor processor 115 and the image server 105. The system has been designed as a surveillance system, but may alternatively be used in any suitable environment.

1. Image Sensor and Image Sensor Processor

The image sensor 125 of the preferred embodiment functions to capture the image data. It is preferably a solid-state sensor, but alternatively may be any type of image sensor. Another variant of the image sensor is a video encoder circuit to allow incorporation of legacy analog video cameras into the system 100 as an in-place replacement for digital sensors. Preferably, the fields of view of the image sensors are overlapping.

The image sensor processor 115 of the preferred embodiment functions to control the image sensor 125 and to, at least some portion of the time, output at least two image data streams to the image server. The image data streams differ in their data rate per unit area of the sensor field of view. One image data stream preferably includes a higher data rate per unit area, while the other image data stream preferably includes a lower data rate per unit area. The image sensor processor 115 is preferably a field programmable gate array (FPGA) that controls the image sensor 125, provides the functionalities of image data stream windowing and down-sampling, and electronics for driving the cable over long distances, or for wireless communication. The image processing and data serialization preferably included in the image sensor processor 115 preferably provide a high-resolution digital image sensors 125 over an inexpensive network connection.

The image sensor processor 115 may transmit multiple image data streams of the same sensor field of view. As an example, the image data streams may include (a) an “archival image data stream” with a full field of view, full resolution, and full frame rate to a server for archiving purposes, (b) a “detailed image data stream” of a portion of the field of view, and (c) a “contextual image data stream” of a full field of view. The detailed image data stream preferably has a high rate per unit area of the sensor field of view, while the contextual image data stream has a low rate per unit area of the sensor field of view. The high rate per unit area of the sensor field of view is preferably accomplished with full resolution and full frame rate, while the low data rate per unit area of the sensor field of view is preferably accomplished with (a) reduced resolution, (b) reduced frame rate, or (c) reduced resolution and reduced frame rate. The reduced data rate per unit area of the sensor field of view image data stream is preferably downsampled, but alternatively may be compressed, or downsampled and compressed.

As shown in FIG. 2, the main internal functional blocks of the image sensor processor 216 include de-serialization F201, command decoding F203, downsampling F211, windowing F207, and serialization F209. The internal functional blocks may be implemented in individual electronic components, Field Programmable Gate Arrays, Application Specific Integrated Circuits, or any combination of FPGA, ASIC, or electronic or mechanical components.

The de-serialization block F201 functions to convert serialized commands into their original form and preferably transmits the de-serialized commands to the command decoder F203, while the command decoding block F203 functions to interpret commands and parameters received from the image server and adjusts the sensor controller parameters accordingly. These adjustments preferably include setting internal control registers for the downsampling block F211 and window selection block F207 as well as register settings inside the image sensor itself. The command decoding block is preferably a simple embedded CPU that is programmed to receive and interpret the commands and parameters received from the image server 105.

The downsampling block F211 functions to produce an overview of the full field of view of the image sensor 225. The overview image is preferably produced by discarding pixels along each row as well as entire rows. For example 4:1 downsampling in both the horizontal and vertical image dimensions would convert a 1920×1080 image into a 480×270 image, with a 16× data reduction. The downsampling block may additionally or alternatively decrease the frame rates of image data.

The windowing block F207 functions to extract full resolution windows (may also be referred to as regions of interest) from the original data. Many different windows may be extracted from the same image frame, subject to bandwidth limitations of the communication link. The maximum number of possible windows is determined by the particular design of the FPGA, which may be electronically updated to suit different applications, or alternatively by the design of the ASIC.

The serialization block F209 functions to take in lines of data from the overview image as well as the individual windows and serializes them for transmission back to the image server 105. A small amount of time at the end of each line is available to send back high-priority image sensor processor status information. A larger amount of time after each frame is also available for status information.

The image sensor processor may also include a Low Voltage Differential Signal (LVDS) buffering block F213, which functions to provide high speed differential transmission with adjustment for cable loss effects at high speed. The LVDS buffering block is preferably an external chip, but the LVDS buffering block may be integrated into an ASIC along with other functional blocks, or the LVDS buffering block may be a separate chip or electronic circuit.

2. Image Server and Communication Link

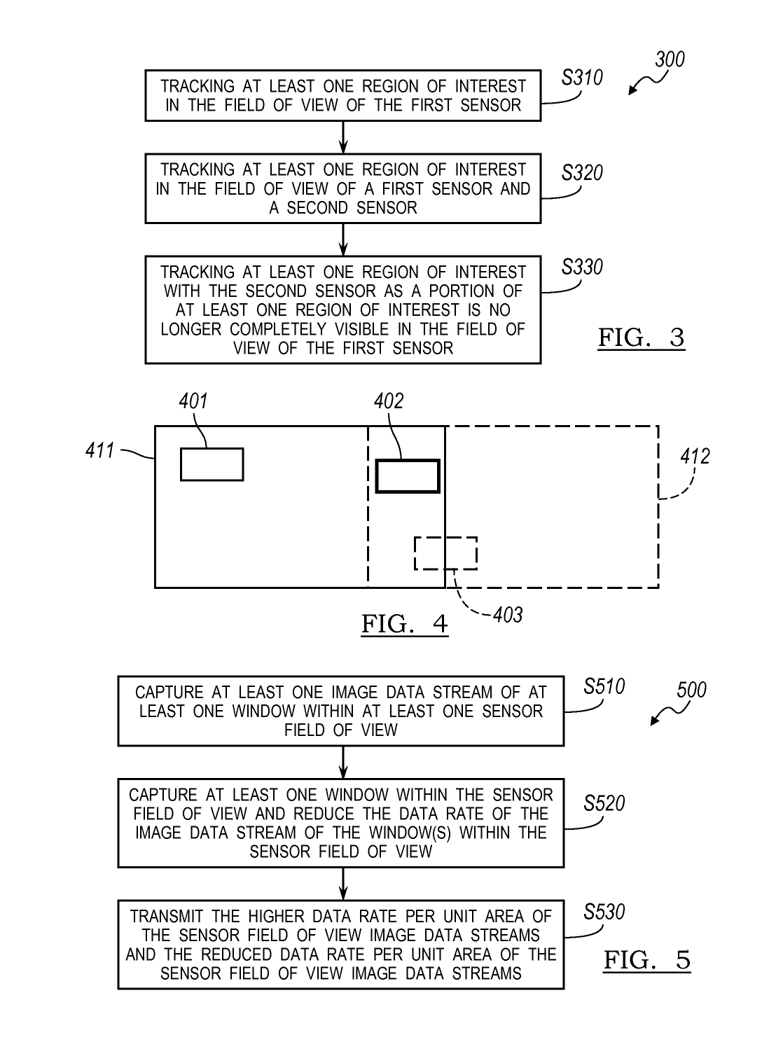

The image server 105 of the preferred embodiment functions to control the image sensors 125. The image server 105 preferably controls the image sensors by identifying an object and controlling the image sensor processors 115 such that the region of interest of the first image sensor and the region of the interest of the second image sensor provide information about the object. As shown in FIG. 3, the method 300 of tracking at least one region of interest from a first image sensor field of view to a second image sensor field of view includes tracking at least one region of interest in the field of view of the first sensor S310, tracking at least one region of interest in the field of view of a first sensor and a second sensor S320, and tracking at least one region of interest with the second sensor as a portion of at least one region of interest is no longer completely visible in the field of view of the first sensor S330. The region of interest is preferably a windowed area within the sensor field of view or sensor array. As shown in FIGS. 3 and 4, Step S310 functions to track at least one region of interest 401 (preferably a window) within at least one field of view 411,412 of at least one image sensor. The region of interest 401 is preferably tracked as long as it is entirely within the field of view 411 of the image sensor. If the region of interest 401 is no longer entirely within the field of view 411 of the image sensor, it may be broken down into smaller regions of interest that are independently tracked. This may be particularly useful for larger regions of interest. Step S320 functions to track a region of interest 402 with multiple sensors. As the region of interest 401 passes entirely into the field of view 412 of at least one additional sensor, the region of interest 402 is tracked for as long the region of interest is entirely within the field of view 411, 412 of any sensor. When a window moves into an overlap zone, a second window is created on the remote head whose field of view overlaps. As the original window starts to move off the edge of its field of view, the second window is substituted by the image server. Step S330 functions to stop tracking a region of interest 402 with at least one sensor when the region of interest 403 is no longer within the field of view of a particular sensor 411. When any portion of the region of interest 402 leaves the field of view of any sensor 411, that sensor stops tracking the region of interest 402, and the region of interest 403 is tracked only by the sensor(s) which have the region of interest 403 completely within the sensor field of view 412.

The image server 105 of the preferred embodiment also functions to synchronize the image sensor processors 115, which improves association between objects in one image sensor field of view and objects sensed in another image sensor field of view. In this manner, the image server 105 preferably sends synchronization commands to the image sensor processors 115. The image server 105 preferably also includes functionality for synchronizing many image sensors 125 without additional wiring. This synchronization is preferably performed using an IEEE 1394 compatible protocol, but may alternatively use any suitable protocol. The command channel provides a means for the image server 105 to communicate parameter settings (such as window locations) with at least one image sensor processor 115, preferably through the use of a private command protocol. One command is preferably allocated as a “frame sync” command that is issued periodically by the image server 105. The periodic synchronization command is preferably transmitted at the rate specified in the IEEE 1394 standard (8000 per second), but may alternatively be issued at a different rate, depending on the local oscillators and/or the required synchronization accuracy. The frame sync is preferably issued to all image sensor processors 115 simultaneously, and used by the image sensor processors 115 to periodically prevent drift in image sensor synchronization due to small differences in the accuracy of the local clock sources of the image sensors 125. The image sensors 125 are preferably synchronized, and this allows the image server 105 to fuse images from multiple image sensors 125, to align and/or stitch multiple overviews together, and to merge views taken by image sensors 125 of different types and resolutions such as high-resolution visible and low-resolution infrared. The image server 105 may also include seamless windowing across multiple sensors, and cascading camera functionality. Seamless windowing across multiple sensors is accomplished by providing overlap in sensor fields of view, as shown in FIG. 4. Individual sensor windows are preferably controlled to provide movement within a particular image sensor's field of view. Setup and calibration of sensor fields-of-view can be labor intensive. This system preferably leverages the processing capacity of the image server 105 to assist in initial alignment by performing a real-time frame matching operation between at least two image sensor fields of view. The results of the frame matching may be used to provide visual positioning feedback to guide a setup technician, preferably using an LED or other visual status indications on the image sensor processor 115. The image server 105 is preferably implemented as a low cost network appliance.

The communication link 110 of the preferred embodiment functions to connect the image sensors 115 and the image server 105. In the first variation, as shown in FIG. 1A, the image sensors 115 are directly connected to the image server 105. In a second variation, as shown in FIG. 1B, the image sensor processors 115 may be connected through daisy-chained communication links 110 rather than connected directly to the image server 105. The image sensor processor 115 may allow relay of commands to another image sensor processor 115 farther up the chain if the address does not match its own. Image information flows back to the image server 105 and is merged at each point in the daisy chain. A daisy chain implies limitation of image sensor processor bandwidth relative to a point-to-point topology, since information from all image sensors 125 together must flow across a single link at the point closest to the image server 105. Since the IEEE 1394 communication protocol supports both the star topology configuration and the daisy-chain configuration (as well as other configurations), the communication link preferably uses a communication protocol that is IEEE 1394 compatible. Bandwidth from any particular image sensor 125 is easily regulated by controlling the size and number of windows, along with the data rates of the overview image data stream. In a third variation, the image sensor processors 115 may use wireless node hopping or mesh networking technologies to relay information to an image server 105. The communication links 110 are preferably standard Category-5 (CAT-5) network cable, chosen for its commonality and low cost compared to other types of cabling. However, any type of communication link 110 may be used such as telephone cable, CAT-3 cable, CAT-6 cable, coaxial cable, power cable, or wireless. As shown in FIG. 2, the four pairs of wires in the CAT-5 are preferably allocated with one pair (D1) providing power, the second pair (D4) providing a means of sending commands to the image sensor processor 115, and the final two pairs (D2, D3) being used to send serialized image data streams and status back to the image server 105.

3. Method of Capturing and Transmitting Images

As shown in FIGS. 5-7, a portion of the preferred method of capturing and transmitting image data streams includes capturing image data of at least one window within at least one sensor field of view S510, reducing the data rate per unit area of the sensor field of view image data stream S520, and transmitting at least one higher data rate per unit area of the sensor field of view image data stream and at least one data rate per unit area of the sensor field of view image data stream to an image server S530.

Step S510 functions to capture image data of at least one window within at least one sensor field of view. The window, which is within the sensor field of view, is a portion of the sensor field of view or the entire sensor field of view. The image data streams may be at a reduced data rate, preferably a reduced resolution, but may alternatively or additionally be at a reduced frame rate. If a lower level of detail is acceptable for the window, however, the reduced data rate is preferably higher data rate per unit area of the sensor field of view than the reduced data rate image data stream produced in Step S520. The data rate per unit area of the resolution is preferably measured in pixels, however the unit area could be square centimeters, square inches, or any other unit area measurement.

Step S520 functions to capture at least one window within the sensor field of view and reduce the data rate of the image data stream from this window. The captured window, which is preferably larger than the captured window of other image data streams, is preferably the entire sensor field of view. The captured window is useful to provide context to the regions of interest. This data rate reduction processing preferably includes the entire image data stream. In one variation, Step S520 may not reduce the data rate of the windowed regions of interest. In another variation, Step S520 may ignore the windowed regions of interest entirely, and drop them from the contextual image data stream, as higher data rate per unit area of the sensor field of view image data streams of the regions of interest were captured in Step S510.

Step S530 functions to transmit the higher data rate per unit area of the sensor field of view image data streams and the reduced data rate per unit area of the sensor field of view image data streams. At least one higher data rate per unit area of the sensor field of view image data stream of at least one windowed region of interest is preferably combined with the reduced data rate per unit area of the sensor field of view image data stream. The higher data rate per unit area of the sensor field of view image data streams may be combined with the reduced data rate per unit area of the sensor field of view image data streams by inserting the former image data stream into the corresponding location of the windowed region of interest in the latter image data stream, or the former image data stream may be transmitted before, during, after, interspersed with, or in parallel with the latter image data stream. Additional processing for compression may also be used prior to transmission, such as loss-less predictive coding. In one variation of the method, in which the reduced data rate per unit area of the sensor field of view image data streams may have dropped the information for each region of interest, the higher data rate per unit area of the sensor field of view image data stream may inserted into the reduced data rate per unit area of the sensor field of view image data stream on the receiving end of the transmission.

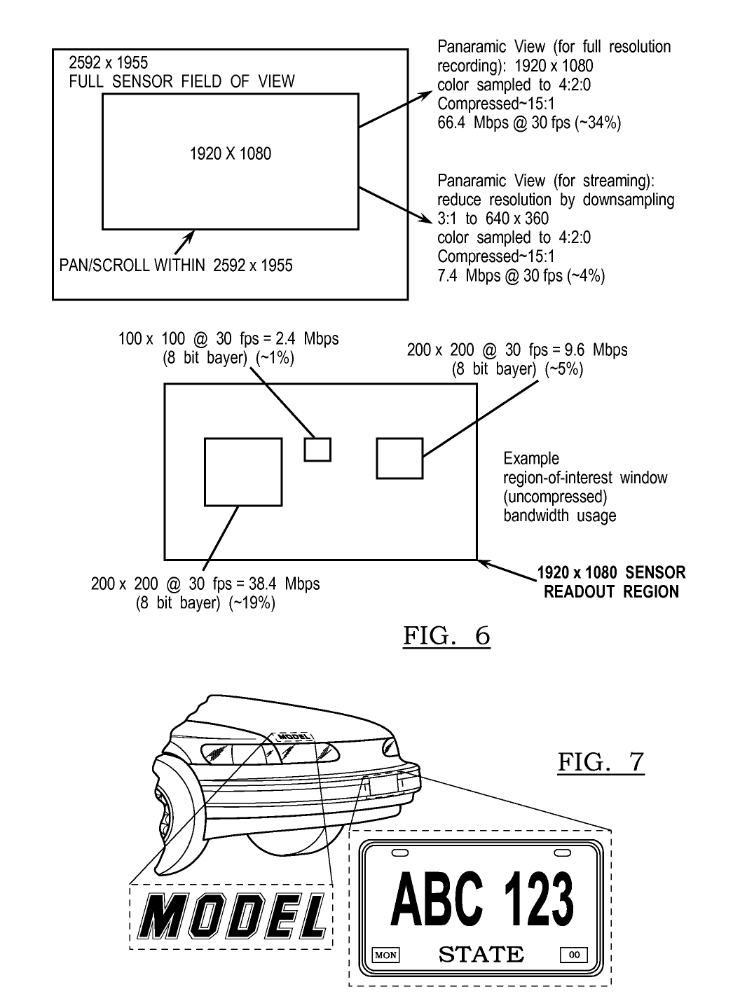

As shown in FIG. 6, two examples of communication capacities for a sensor field of view with higher data rate per unit area of the sensor field of view image data stream windows of varying sizes and the associated compressions and capacity usages when transmitted over a 200 Mbps Firewire communication link. The top example shown in FIG. 6 may be a higher data rate per unit area of the sensor field of view image data stream window within the full field of view of the sensor, which may be transmitted to an archival server. This higher data rate per unit area of the sensor field of view image data stream may also be the full resolution and/or full frame rate of the full field of view of the sensor. As shown in the bottom example in FIG. 6, the windowed image data streams may be transmitted at higher data rate per unit area of the sensor field of view image data streams and the remaining areas of the image data stream may be transmitted as reduced data rate per unit area of the sensor field of view image data streams. The reduced data rate per unit area of the sensor field of view image data stream may correspond to the sensor readout region or of the entire sensor field of view.

As shown in FIG. 7, an example image data stream where only the model, license number, and license expiration date of a car might be of interest, and are transmitted at a higher data rate per unit area of the sensor field of view image data stream, preferably with a reduced data rate per unit area of the sensor field of view image data stream. Preferably, only areas where detail is necessary are sent at a higher data rate per unit area of the sensor field of view image data stream. An overview of the entire field of view is useful to provide context, a parking space in this case, and is preferably sent at a reduced data rate per unit area of the sensor field of view image data stream, to use bandwidth more efficiently. The overview is preferably produced by discarding or degrading information from the original image, including downsampling, resolution reduction, frame rate reduction, or may be produced by image or video compression (lossy, or lossless).

As a person skilled in the art will recognize from the previous detailed description and from the figures and claims, modifications and changes can be made to the preferred embodiments of the invention without departing from the scope of this invention defined in the following claims.

1. A method of capturing and transmitting image data streams comprising the steps of:
capturing image data with a image sensor;
creating a window within the image data and creating a detailed image data stream based on the windowed image data;
reducing the image data and creating a contextual image data stream based on the reduced image data; and
transmitting the detailed image data stream and the contextual image data stream.

2. The method of claim 1, wherein the steps of windowing the image data and creating a detailed image data stream based on the windowed image data, and reducing the image data and creating a contextual image data stream based on the reduced image data, occur substantially in parallel.

3. The method of claim 1, wherein windowing the image data includes extracting a portion of the field of view of the image sensor.

4. The method of claim 1, wherein reducing the image data includes using the full field of view of the image sensor.

5. The method of claim 1, wherein reducing the image data includes reducing the resolution of the image data.

6. The method of claim 1, wherein reducing the image data includes reducing the frame rate of the image data.

7. The method of claim 1, wherein the data rate per unit area of the sensor field of view of the detailed image data stream is greater than the data rate per unit area of the sensor field of view of the contextual image data stream.

8. The method of claim 1, further comprising the steps of creating a second window with the image data and creating a second detailed image data stream based on the second windowed image data; wherein the step of transmitting the image data streams includes transmitting the second detailed image data stream.

9. (canceled)

10. The method of claim 1, wherein the step of transmitting the image data streams further includes transmitting the data streams over Category 5 cable.

11. (canceled)

12. The method of claim 1, further comprising the steps of:
capturing image data with a second image sensor; windowing the image data from the second image sensor and creating a second detailed image data stream based on the windowed image data from the second image sensor; reducing the image data of the second image sensor and creating a second contextual image data stream based on the reduced image data from the second image sensor; and transmitting the second detailed image data stream and the second contextual image data stream.

13. (canceled)

14. The method of claim 12, further comprising the step of identifying an object in at least one of the image data streams.

15. The method of claim 14, further comprising the step of controlling the first image sensor and the second image sensor based on the identification of the object such that at least one of the first detailed image data stream and the second detailed image data stream provides information about the object.

16. (canceled)

17. The method of claim 12, further comprising the step of substantially maintaining the synchronization of the first image sensor and the second image sensor.

18. The method of claim 12, further comprising the step of providing a signal based on an orientation of the first image sensor relative to the orientation of the second image sensor.

19. (canceled)

20. The method of claim 12, further comprising the steps of:
capturing image data with a third image sensor; windowing the image data from the third image sensor and creating a third detailed image data stream based on the windowed image data from the third image sensor; reducing the image data of the third image sensor and creating a third contextual image data stream based on the reduced image data from the third image sensor; and transmitting the third detailed image data stream and the third contextual image data stream.

21. A system for capturing and transmitting image data streams comprising:
an image sensor processor having
a first processor means for creating a window within the image data and creating a detailed image data stream based on the windowed image data,
a second processor means for reducing the image data and creating a contextual image data stream based on the reduced image data, and
means for transmitting the detailed image data stream and the contextual image data stream.

22. The system of claim 21, wherein the first processor means and the second means perform substantially in parallel.

23. The system of claim 21, wherein the first processor means extracts a portion of the field of view of the image sensor.

24. The system of claim 21, wherein the second processor means uses the full field of view of the image sensor.

25. The system of claim 21, wherein the second processor means reduces the resolution of the image data.

26. The system of claim 21, wherein the second processor means reduces the frame rate of the image data.

27. The system of claim 21, wherein the data rate per unit area of the sensor field of view of the detailed image data stream is greater than the data rate per unit area of the sensor field of view of the contextual image data stream.

28. (canceled)

29. The system of claim 21, wherein the means for transmitting includes transmitting the image data streams over Category 5 cable.

30. (canceled)

31. The system of claim 21, further comprising:
a second image sensor processor having
a first processor means for creating a window within the image data and creating a second detailed image data stream based on the windowed image data,
a second processor means for reducing the image data and creating a second contextual image data stream based on the reduced image data, and
means for transmitting the second detailed image data stream and the second contextual image data stream.

32. The system of claim 31, further comprising an image server adapted to control the first image sensor processor and the second image sensor processor, wherein the image server includes a means for identifying an object in at least one of the image data streams.

33. (canceled)
